(19) United States
(12) Patent Application Publication
(10) Pub. No.: US 2008/0212732 A1
(43) Pub. Date: Sep. 4, 2008

(54) Tub-Type Meltdown Retaining Device

(75) Inventor: Bruno Wilhelmi, Spiesheim (DE)

Correspondence Address: WALKER & JOCKE, L.P.A., 231 SOUTH BROADWAY STREET, MEDINA, OH, 44256, US

(73) Assignee: REFRACTORY INTELLECTUAL PROPERTY GMBH & CO. KG, Wien (AT)

(21) Appl. No.: 11/994,356

(22) PCT Filed: Jun. 24, 2006
(86) PCT No.: PCT/EP2006/006107

§ 371 Date: Feb. 1, 2008

(30) Foreign Application Priority Data
Jul. 11, 2005 (DE) 102005032253.0

(51) Int. Cl. G21C 9/016

(52) U.S. Cl. 376/280

(57) ABSTRACT

The invention relates to a Tub-like retainer for a nuclear core melt, comprising an outer envelope with a multi-layer lining along its inner surface, wherein said lining comprises, from inside to outside, a monolithic sacrificial layer, a layer made of high temperature resistant shaped parts and a monolithic filling layer between said envelope and said layer made of shaped parts.

The present invention relates to a tank-type (tub-type) retention device for a core meltdown, such as could occur in a very major incident in a nuclear power installation. Although such a major incident is regarded as extremely unlikely by the manufacturers and operators of nuclear power installations, nevertheless appropriate precautions must obviously be taken to deal with such an eventuality.

The incident that occurred in the Chernobyl nuclear reactor showed that a major problem consists in trapping, compensating or dissipating the enormous amount of heat generated by the meltdown, without destroying the whole installation and thereby releasing radioactive radiation.

In recent years new types of reactors have been developed. These include the so-called pebble-bed reactor. Fuel rods are replaced by graphite spheres in the shape of tennis balls, into which uranium pellets are inserted. These graphite spheres should not heat up to more than 1600° C.

The new types of reactors also include the so-called EPR (European Pressure Reactor). Details can be found under www.framatome-anp.com.

The basic concept on which the invention is based is to provide, in the unlikely event of a core meltdown, a retention device that simultaneously satisfies several functions:
the retention device holds the meltdown and prevents its uncontrolled distribution
the retention device extracts heat from the meltdown without excessive cooling
the retention device provides a defined space, from which the melt can subsequently be transferred to subordinate parts of the installation.

In order to be able to meet these various tasks, a retention device according to the invention includes an outer envelope, which comprises on the inside a multilayer lining, wherein the lining includes, from the inside to the outside, a monolithic sacrificial layer, a layer of moulded parts, and a monolithic filling layer between the envelope and layer consisting of moulded parts. In other words, the lining includes at least three different layers, which also accomplish different tasks. At least two layers consist of a refractory, in particular ceramic material. The retention device is arranged directly underneath the associated reactor pressure vessel containing the fuel elements. In this connection the pressure vessel can project into the retention tank.

The sacrificial layer on the inside is the first to come into contact with the formed melt in the event of an outflow of the meltdown from the reactor pressure vessel. The temperature of a meltdown is >2000° C.

Although the sacrificial layer can consist of a material that is resistant to temperatures above 1000° C. or above 1500° C., it is clear that the sacrificial layer, as its name suggests, is eroded or destroyed by the extremely hot meltdown. This is not only taken into account but is indeed expressly desired. Accordingly the sacrificial layer need not be unnecessarily refractive (=high temperature resistant). First of all there is an initial dramatic reduction in the temperature of the melt, which is now a mixture of the meltdown (material of the fuel elements as well as their casing) and the sacrificial layer. At the same time the density of the overall mixture is reduced compared to the density of the meltdown.

Within the context of the invention the object is to form the sacrificial layer of a material which, on contact with a meltdown, absorbs not only accumulated heat but also leads to endothermic reactions, i.e. reactions in which additional heat is consumed. In this way the temperature of the melt contained in the retention device is reduced still further.

According to one embodiment the sacrificial layer consists of a normal construction concrete or of a concrete with a high alumina (Al₂O₃) content, i.e. a so-called refractory concrete.

This sacrificial layer lies in front of the so-called moulded parts layer, which consists for example of ceramically bound moulded parts. Such moulded parts, for example bricks or panels, can be assembled into stable walls and floors, and serve to form a thermally and mechanically stable layer. Materials based on zirconium oxide are particularly advantageous, since they withstand high temperatures and have a high mechanical strength. Materials with a proportion of ≧90 wt. % ZrO₂ can be used for the production of the aforementioned moulded parts. RHI AG, Vienna, markets such zirconium oxide-containing bricks under the trade mark ZETTRAL 95 GR. The essential raw material component is partially stabilised ZrO₂. The bricks are ceramically bound and contain, apart from ca. 93 wt. % ZrO₂, about 4 wt. % MgO and ca. 1.5 wt. % SiO₂ (apart from usual impurities). Their bulk density is 4.4 g/cm³ (measured according to EN 993-1). The compression strength (according to EN 993-5) at room temperature is ca. 110 N/mm². The open porosity (measured according to EN 993-1) is ca. 18 vol. %. The thermal data are as follows: the coefficient of linear expansion (at 1600° C.) is 0.8%. The T_{0.5} value for the pressure load test according to EN 993-8 is about 1650° C.

Such bricks have previously been used only in special glass tanks, and have found a novel application within the scope of the present invention.

Adjacent moulded parts can be attached to one another via interlocking elements, for example known groove and tongue connections.

In order to improve the stability of the moulded parts layer as a whole, it may be expedient to secure at least individual moulded parts by means of connecting elements or anchors to the outer envelope of the retention device. Examples of these are disclosed in BP 1 124 094 A1 and DE 44 20 294 C2, the disclosures of which are referred to here.

This applies in particular if the outer envelope is a metal envelope, which situation will be discussed later.

According to the invention at least one further layer is provided between the moulded parts layer and the outer envelope of the retention device. This so-called filling layer is formed with the aid of a monolithic composition, which can consist of a material having a high thermal conductivity. In this way the dissipation of heat from the moulded parts layer lying in front of the filling layer is promoted and accelerated. The thermal conductivity should for example be ≧5 W/m·K. If there is a fairly large amount of sacrificial concrete, the thermal conductivity of the filling layer is less important and can even be <5 W/m·K.

Suitable materials for the filling layer are refractory ceramic masses with a content of carbon. The carbon can be present as such, for example in the form of graphite. Also suitable however are filling layers based on a SiC-containing composition.

For other applications high temperature-resistant filling layers based on ZrO₂, Al₂O₃, MgO or mixtures thereof can also be advantageous. Such compositions can be produced for example from ZrO₂ powder and a binder. They can be processed largely free of shrinkage cavities by vibration devices, but can also be formulated as ramming mixtures. If liquid binders are used, then any water content will be expelled by a thermal preliminary treatment of the filling layer.

As already mentioned above, the outer envelope of the retention device can be a metal envelope. This envelope can lie at least in part in a (further) concrete tank, which encloses and supports the whole retention device.

The envelope can however also at least in part consist of a (optionally also high temperature-resistant) ceramic material, for example a material of the aforementioned type. Such materials also include concrete. Any connecting elements between the moulded parts layer and the envelope are then suitably secured in or to the ceramic material of the envelope.

Within the scope of ongoing design and project work, the following thicknesses for the individual layers have proved suitable:
Sacrificial layer: 20-80 cm, in particular 35-65 cm, for example 45-55 cm.
Moulded parts layer: 10-40 cm, in particular 15-30 cm, for example 16-25 cm.
Filling layer: 1-10 cm, in particular 2-8 cm, for

example 4-6 cm.
Concrete tank; up to several metres.

It is possible, within the scope of the invention to provide the cup-shaped or tank-shaped retention device, into which the reactor pressure vessel together with the fuel elements projects, with a discharge region, which can be opened if necessary in order to be able to transfer the meltdown or the meltdown/sacrificial layer mixture to subordinate devices. According to one embodiment the tank-type retention device includes for this purpose a plug (or a regulating valve) in the floor, which can be opened or melts, and guides the melt into a channel, via which the melt passes to a containment tank. In this connection at least the channel subordinate to the retention device can likewise be formed with a high temperature-resistant lining, as described in connection with the retention device. On account of the cooling of the melt in the retention device and possibly in the channel, the containment tank does not require a refractory lining.

The invention is described in more detail hereinafter by way of example:

In this connection the starting point is an installation, in which the reactor vessel projects into the retention device according to the invention and, which is extremely unlikely, a meltdown occurred.

The meltdown is first of all trapped by the tank-type retention device. The radioactive melt comes into contact with the material of the sacrificial layer. According to calculations the meltdown “consumes” 70-90% of the sacrificial layer within 100 minutes after coming into contact with it; the sacrificial layer melts and the mixed melt thereby formed cools at the same time. The composition and temperature of the resultant mixed melt change accordingly.

According to design calculations the content of UO₂ and ZrO₂ in the mixed melt falls constantly, whereas for example the SiO₂ and CaO contents of the mixed melt rise (whereas ZrO₂ and UO₂ are constituents of the meltdown, SiO₂ and CaO are predominantly constituents of the sacrificial layer.

In addition, due to the use of the tank according to the invention a reduction of the temperature of the mixed melt of about 100° C. per hour can be expected.

Where high temperature-resistant materials are discussed within the context of the present description, these are understood to be materials that in any case are temperature-resistant at >1000° C., preferably above 1500° C., unless otherwise stated. There is no upper limit. The described moulded parts based on ZrO₂ can have a temperature resistance above 1900° C., and are resistant for at least 3 hours to a melt at a temperature of 1900° C.

1. Tank-type core meltdown retention device, with an outer envelope that has on the inside a multilayer lining, wherein the lining, from the inside to the outside, includes a monolithic sacrificial layer, a layer of high temperature-resistant moulded parts, and a monolithic filling layer between the envelope and moulded parts layer.

2. Retention device according to claim 1, in which the sacrificial layer consists of a material that on contact with a meltdown leads to endothermic reactions.

3. Retention device according to claim 1, in which the sacrificial layer consists of concrete.

4. Retention device according to claim 1, in which the moulded parts layer consists of ceramically bound moulded parts.

5. Retention device according to claim 1, in which the moulded parts layer consists of moulded parts based on ZrO₂.

6. Retention device according to claim 1, in which the moulded parts layer consists of moulded parts containing ≧90 wt. % ZrO₂.

7. Retention device according to claim 1, in which the moulded parts layer consists of moulded parts joined to one another in an interlocking manner.

8. Retention device according to claim 1, in which the filling layer consists of a material having a high thermal conductivity.

9. Retention device according to claim 1, in which the filling layer has a thermal conductivity ≧5 W/m·K.

10. Retention device according to claim 1, in which the filling layer contains carbon.

11. Retention device according to claim 1, in which the filling layer consists of a SiC-containing composition.

12. Retention device according to claim 1, in which the filling layer consists of a ZrO₂-containing composition.

13. Retention device according to claim 1, in which the envelope is a metal envelope.

14. Retention device according to claim 1, in which the envelope lies at least partly in a concrete tank.

15. Retention device according to claim 1, in which the envelope consists at least in part of a high temperature-resistant ceramic material.

16. Retention device according to claim 1, in which the envelope consists at least in part of concrete.

17. Retention device according to claim 1, in which the envelope is formed at least in part by a concrete tank.

18. Retention device according to claim 1, with a discharge opening and a channel connected thereto, which has a high temperature-resistant lining corresponding to the retention device.
